(19) United States
(12) Patent Application Publication
(10) Pub. No.: US 2004/0128882 A1
(43) Pub. Date: Jul. 8, 2004

(54) Indication sign

(76) Inventor: Hagen Glass, Munchen (DE)

Correspondence Address: Bachman & LaPointe, Suite 1201, 900 Chapel Street, New Haven, CT, 06510-2802, US

(21) Appl. No.: 10/468,550

(22) PCT Filed: Feb. 22, 2002
(86) PCT No.: PCT/EP02/01901

(30) Foreign Application Priority Data
Feb. 22, 2001 (DE) 201 03 133.7

(51) Int. Cl. G09F 13/22

(52) U.S. Cl. 40/544

(57) ABSTRACT

The invention relates to an indication sign consisting of an at least partially flat support element (10) provided with at least one opening (12) for producing a printed image, a graphic representation and/or a line of characters, whereby said at least partially flat support element (10) is connected on one flat side thereof to a flat electro-luminesence based or luminescent polymer (14), or by means of an illuminated acrylic glass, in order to form backlighting. The opening (12) is filled with at least one partially translucent filling material, particularly a casting resin.

The present invention concerns an indication sign device which in principle can be used in any environment to generate luminescent, graphic or text information and particularly preferably is used in environments greatly affected by moisture, dirt or mechanical influences e.g. in the automotive or construction sector (typical examples are emergency exits or staircases).

It is known from the prior art to produce information signs for advertising or warning purposes in the form of suitably profiled aluminium elements and to fit these at relevant points e.g. on a sill or scuff plate of a motor vehicle and/or a door step of a bus (or generally the edge of the step). In the dark or poorly lit environment however such indication signs have practically no informative effect, which in particular can have a potentially disadvantageous and dangerous result if such a sign serves to give warning information.

Numerous possibilities are known from the prior art for providing illuminated information in the form e.g. of a suitably arranged LED chain, a top-lit illumination or similar. In particular in a mobile environment however the use of such technologies is pointless as either a considerable power consumption is associated with the known light sources or the physical dimensions (in particular thickness) of conventional lighting elements prevent use in conjunction with a flat (preferably plate-like) indication sign. In addition many lighting elements are unsuitable for use in environments in which there are particular risks from dirt, moisture or extreme temperature influences or from very high mechanical stresses (e.g. vandalism, high frequency of use etc.).

The object of the present invention is therefore to create an indication sign which even in dark or poorly lit environments can develop its full information effect while not being sensitive to extreme ambient influences, and be suitable—in particular with regard to its energy consumption and compact, in particular flat dimensions—for use in the building sector and for mobile use, in particular in motor vehicles.

This object is achieved by the indication sign with the features of claim 1; independent protection within the scope of the invention is also claimed for an invention with the features of claim 7 and a use according to claim 10. Advantageous refinements of the invention are described in the sub-claims.

Advantageously according to the invention the indication sign achieves with back lighting an advertising or warning effect in a flat compact manner, where as well as the favourable dimensions, firstly the design of the text, graphic representation or series of characters is created according to the invention by at least one opening of the full surface protection of the underlying lighting unit (through the carrier element itself or through the openings filled with the filling material), and secondly the invention achieves advantageous optical conditions and maximum flexibility in production, patterning and coloration of the desired design. In this context it is in particular also possible to design the connection between the carrier element and the lighting unit detachable or removable in order thus to achieve maximum flexibility, for example by the exchange of one of the elements for a lighted stair profile.

As a result the present invention creates a compact, mechanically stable arrangement with flexible use (protected correspondingly against environmental influences) which in a surprising simple manner solves the dilemma of existing flat and unlit indication signs.

For the expert it is self-evident that the lighting unit according to the invention can have any power supply or control elements which as well as permanent light control in particular allow varying light patterns, sequences of individual image or text elements, flickering or similar light patterns by otherwise known control methods. It should also be pointed out that the electro-luminescence elements used for preference for the light unit combine pleasant lighting qualities with extremely favourable power consumption and long life so that here a suitable instrument has been developed in particular for permanent applications. As part of the invention the term “electro-luminescence” should be understood to include in particular “organic” electro-luminescence in the form of light-emitting polymers (also known as light polymers). In particular in view of the fact that such elements require no glass carriers, these are particularly suitable for use within the context of the present invention.

The said high flexibility and simultaneous protective effect for the underlying light unit arise primarily from the corresponding selection and formation of the filling of the opening with the filling material. While the opening for example can be produced by cutting, milling, stamping, casting, punching or injection moulding, particularly preferably the filling material comprises a two-component PU casting resin. Depending on the selection, coloration and filling depth of the filling material, numerous effects can be achieved such as a permanent coloration of the text or graphic representation, a resulting optical enlargement (filling material correspondingly pronounced through lens effect) of the text, or particular resistance to weathering and UV of the image by selection of the filling material chosen particularly suitably as a two-component casting resin (such as PU because of the environmental harmlessness, adjustable elasticity and resistance to scratching and chafing).

The flexibility for achieving the desired sign form is further increased as part of the present invention by the protective or decor film provided in a refinement which firstly can be designed for permanent interposition between the light unit and the carrier element and thus by corresponding coloration or patterning achieves the suitable optical effect. (The permanent interposition of a protective film has the advantage that the light unit is not firmly connected with the filling material; as a result a simple and economic exchange of the light unit is possible without the opening needing to be refilled with the filling material). Secondly the film, its primary application being a protective film, can be provided merely during production namely for sealing the opening in the carrier element during filling of the opening with filling material, where then after its hardening the protective film can be removed. This embodiment of the invention thus allows production of the entire arrangement with a reduction in the number of errors and rejects, as the filling material can be applied separately from the light unit and thus loading and possible damage of the light unit by the (still) liquid filling material can be avoided.

In this context the introduction or filling of the opening with the filling material is in no way restricted to the casting of the corresponding filling material e.g. the casting resin in its liquid state. Rather the present invention (also) covers the design of the casting material (filling material) where applicable also with a light unit of adapted surface so that this can be inserted in the opening in the carrier element in the form of an inlay. The same applies to the design of the indication sign according to the independent device claim.

Such an insert can itself have its own (integrated) patterning or consist of dyed plastic or synthetic resin material.

This solves particularly advantageously the problem connected with liquid casting resin, that when the carrier material does not have a smooth surface (e.g. the grooves on a step profile), the casting compound cannot be poured cleanly into the opening; the casting compound would flow out uncontrollably on the rough surface. In contrast an inlay, as already produced in a previous working step (e.g. cast), would lead to no disadvantageous outflow.

With regard to the indication sign device according to the independent claim, it should be pointed out that according to a preferred embodiment which is simultaneously an advantageous refinement of the main claim, it is possible to produce the patterning directly by means of the light pigment or the actual light surface applied by a (screen) printing process; in other words with the combination according to the independent claim, the light pigment or electro-luminescent light unit is itself designed to act as a pattern.

In principle the carrier element can be formed as required, where depending on the material used, common procedures for the formation of the opening are suitable and to this extent the present invention includes any applications, however with the emphasis on flat or large-surfaced carrier elements. Preferably the carrier element is made of metal, wood and/or plastic material as a flat, angled or curved element.

Further advantages, features and details of the invention arise from the description below of preferred embodiment examples and with reference to the drawings which show:

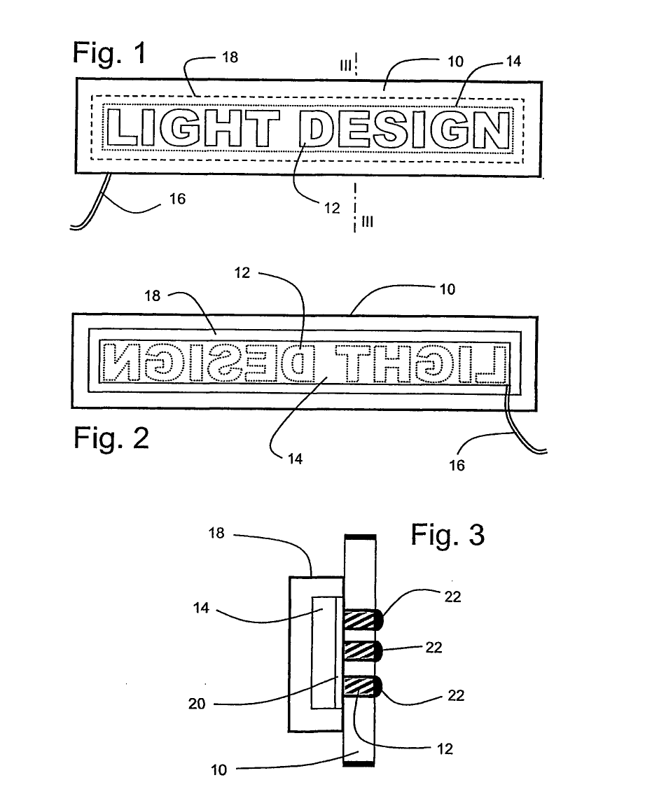

FIG. 1: a front view of an indication sign according to the invention according to a first preferred embodiment of the invention;

FIG. 2: a rearward view of the device according to FIG. 1, and

FIG. 3: a side view along cut line III in FIG. 1.

A carrier element 10 consisting of an aluminium plate has a multiplicity of corresponding letter contours in the form of cut openings 12 which, as shown in FIG. 1, provide text information. The openings 12 are formed by means of typical working processes e.g. punching, (laser) cutting etc.

As is evident in particular from the cut-away view in FIG. 3, the punched text in the carrier unit 10 according to FIG. 1, FIG. 2 is back lit by a flat lighting unit 14 present in the form of a strip below the openings and running parallel to the carrier element 10. The lighting element 14 is implemented as an electro-luminescence lighting element (in particular an inorganic thick layer EL element) i.e. as a homogeneous lighting surface (strip-like here) where the lighting effect is achieved in an otherwise known method by electro-luminescence excited by a supply voltage which can be directed to a supply line 16, or provided by another preconnected unit (converter).

Light surfaces acting by electro-luminescence are adequately known from the state of the art and are available via normal distributors in various surface dimensions, maximum light intensities and light densities, base colours etc. Advantageously the electro-luminescence (EL) light used for preference according to the invention has a homogeneous light emission without dazzle point or shadow surfaces; also depending on a suitably selected electronic control, an almost smooth brightness adjustment is possible together with colour temperature change by suitable setting of the operating frequency. Further advantages of an electro-luminescence light unit lie in that, in contrast to conventional incandescent lights, there is no sudden failure but ageing phenomena or diminishing power are expressed gradually i.e. by reducing brightness. Also in comparison with incandescent lights, the life is relatively long. Further advantages are the low power consumption achieved by the high efficiency, the absence of heating (as they are cold light sources, temperature-sensitivity is not relevant with appropriate carrier materials), short times for switching to an effect mode, and largely flicker-free, clearly visible (due to precise contours) light. From a mechanical aspect there are also the advantages of a flat light source which is also flexible and has low weight, can be walked on and is vibration-resistant.

As shown also in the cross-section view in FIG. 3, between the light element 14 and the carrier element 10 can be inserted a decor film 20 which, suitably dyed or patterned, allows individual coloration or colour design of the (EL) light emerging through the letter cut-outs 12. Preferably this decor or protective film is self-adhesive or attached by means of a (single- or double-sided) adhesive tape.

Since in the present invention the letter cut-outs 12 are also filled with a PU resin casting compound, the film 20 also serves as a protective film: namely and in particular during filling of the openings 12 with the filling material (casting resin), the light unit 14 should be kept separate from the carrier element 10 to avoid damage from the liquid casting resin. The protective film 20 however allows either casting (filling) with the lighting element mounted or serves as a (preferably removable) protective film at the time of filling and until setting of the filling compound.

Various methods are possible for attaching the light surface to the carrier element 10 (with or without intermediate decor film 20). For example it is suitable to glue the EL lighting element to the back of the carrier element 10. This is preferably achieved in that the EL lighting surface is self-adhesive or attached by means of a single- or double-sided adhesive tape. The EL light film is preferably laminated (with PE), further increasing electrical and mechanical safety against damage.

Advantageously also the filling material is introduced into the openings 12 so that these protrude over a flat outer surface of the carrier element 10 and form the protrusions indicated with the reference FIG. 22. This allows additional optical effects to be achieved, for example through a lens shape of the cast resin protrusions 22 (alternatively it is also conceivable that the entire surface of the carrier material is covered with casting resin).

A particular, mechanically effective advantage of the invention also lies in that by complete or protruding filling of the opening with the filling material, in particular with large area indication signs with correspondingly large openings, possible risks of injury (e.g. for passengers) from sharp edges of the openings can be avoided.

On the back the lighting element 14 is covered by a housing element 18 so that for the flat overall arrangement as before, a rearward protection of the lighting element 14 against ambient influences can be achieved—to the front (lit side) this is achieved in an advantageous manner according to the invention by the aluminium carrier element 10 or casting resin filling of the openings 12. The cover element 18 can in particular be implemented as an (elastic) adhesive foam or textile strip depending on the actual conditions of use. Alternatively it is also possible that (also) on the rear the carrier element is covered with casting resin for example within a precast mould; to this extent the connection would then be embedded or encapsulated in the casting material so that no separate housing would be required.

In the manner described above therefore a compact although high quality, reliable unit suitable for hard environmental conditions is achieved which is suitable in particular for mobile use e.g. in motor vehicles or in sporting equipment. In the otherwise known manner the supply line 16 is connected with a suitable control or power supply unit which then also according to a refinement advantageously allows the setting of suitable light parameters of the light element 14, as well as brightness and colour temperature where applicable also animation effects such as flashing or dimming. According to a further refinement it is also possible to divide the flat lighting element 14 into a multiplicity of individual surfaces which ideally can be individually allocated to each separate letter (i.e. each particular opening) or to each word. Accordingly here the multiplicity of effects possible through the control system is drastically increased, for example by running light, individual pronounced flashing of words or letters or similar. Whereas it is firstly preferred that the carrier element has an allocated individual opening for each individual surface of the lighting unit, as part of the present invention it is also possible as part of the invention to provide the carrier element with one opening behind which lies a multi-segment light unit (e.g. in the form of an animated company logo, digital clock or similar) so that here there are many possible variations.

It is found that in particular the indication and signal effect of existing i.e. passive or passively lit indication signs can be clearly improved, and that mechanical and electronic implementation poses great problems, or is susceptible to fault in particular under difficult environmental conditions.

The present invention is not restricted to the embodiment example described, so any materials are suitable as carrier elements together with any forms or embodiments of this element. Equally the carrier element can be fitted with (sign) openings in almost any manner; as well as the letters shown, these can in particular also be other graphic or symbol elements which again, depending on the material selected for the carrier, are cut or worked in a suitable production process.

Suitable filling materials in particular are a two-component polyurethane casting resin but also other transparent filling materials.

An alternative embodiment of the lighting element 14 provides the use of a correspondingly flat formed acrylic glass element where this then acts as a light guide for introduced light (e.g. via LEDs, where the LEDs sit in a bore in the glass element); alternatively external light can be introduced by means of a light guide. This variant of the invention is particularly effective if the light or sign effects are created by suitable milling of the acrylic glass surface, for example in the form of characters with corresponding refraction effects. The light introduced into the acrylic glass surface emerges with optical effect precisely at these milled areas.

An alternative embodiment of the invention also claimed provides that a carrier element (10 in FIG. 1) can be completely omitted. Here the sign effect is achieved in that a patterned layer is applied to the EL lighting element (achieved either by an additional film or by direct printing/patterning of the light emergence surface of the EL element) and covered by a casting resin layer as a protective transparent cover. Such a unit, which provides additional advantages in view of the low thickness, is suitable for many applications in particular in the automotive or building sector.

1. Indication sign device with a flat at least in sections carrier element (10) with at least one opening (12) to generate a text image, a graphic representation or a row of characters, which element is connected on its flat side with a flat lighting unit (14) based on electro-luminescence or light polymer or by means of illuminated acrylic glass to form back-lighting, and where the opening (12) is filled with a filling material, in particular a casting resin, at least partly permeable to the light from the light unit.

2. Device according to claim 1, characterised in that in a transition area between the filling material and the lighting unit (14) is provided a transparent decor and/or protective film (20) which further preferably is formed before assembly of the carrier element (10) on the flat light unit (14) and removable after hardening of the filling material.

3. Device according to claim 2, characterised in that the decor and/or protective film is patterned and/or coloured.

4. Device according to claim 2 or 3, characterised in that the decor and/or protective film is multi-layered and has a decor or patterned layer.

5. Device according to any of claims 1 to 4, characterised in that the filling material is introduced into the opening so that on the side of the carrier element opposite the lighting unit this protrudes over an edge of the opening, terminates flush with the edge or has a filling height below the edge and further preferably has an optical lens effect (22).

6. Device according to any of claims 1 to 5, characterised in that the filling material has a colouring and/or is available in various elasticities or degrees of hardness.

7. Device according to any of claims 1 to 6, characterised in that the filling material is inserted in the opening as a moulded inlay, preferably detachable.

8. Indication sign device with a flat light unit based on electro-luminescence or light polymer or implemented by means of illuminated acrylic glass, and an at least partly transparent cast resin layer at least partly covering the lighting unit, where between the lighting unit and the cast resin layer is provided a pattern which is achieved by printing or patterning a surface of the light unit facing the cast resin layer and/or by a decor film provided between the light unit and the cast resin layer and/or engraving of the acrylic glass.

9. Indication sign device according to claim 8, characterised in that the patterning is achieved by a light-effective surface section of the light unit producing a lighting effect surface of the large-surface the light unit.

10. Use of the indication sign device according to any of claims 1 to 9 on or in a motor vehicle, in the building sector, in particular to implement a stair lighting on or in sports equipment or for information signs.
